(19) United States
(12) Patent Application Publication
(10) Pub. No.: US 2020/0252997 A1
(43) Pub. Date: Aug. 6, 2020

(54) Configure Measurement Gaps for CSI-RS from Neighbor Cells in NR

(71) Applicant: Apple Inc., Cupertino, CA (US)

(72) Inventors: Alexander SIROTKIN, Petach Tikva (IL); Candy YIU, Portland, OR (US); Yang TANG, Pleasanton, CA (US); Youn Hyoung HEO, San Jose, CA (US); Jaemin HAN, Hillsboro, OR (US); Jie CUI, Santa Clara, CA (US)

(21) Appl. No.: 16/637,478

(22) PCT Filed: Jul. 17, 2018
(86) PCT No.: PCT/US2018/042479

§ 371 Date: Feb. 7, 2020

Related U.S. Application Data
(60) Provisional application No. 62/545,238, filed on Aug. 14, 2017.

(51) Int. Cl. H04W 88/10; H04W 24/10; H04W 36/00; H04L 1/00; H04L 5/00

(52) U.S. Cl. CPC H04W 88/10; H04W 24/10; H04W 92/20; H04L 1/0026; H04L 5/0051; H04W 36/0088

(57) ABSTRACT

Embodiments of a generation Node-B (gNB), User Equipment (UE) and methods to configure measurement gaps are generally described herein. A serving cell gNB may transmit, to a neighbor cell gNB, a channel state information reference signal (CSI-RS) status request message and may receive, from the neighbor cell gNB 105, a CSI-RS status update message. The serving cell gNB may determine, based on timing information in the CSI-RS status update message, a measurement gap to be reserved for transmission of CSI-RS from the neighbor cell gNB to a UE that is served by the serving cell gNB. The serving cell gNB may transmit, to the UE, control signaling that indicates the measurement gap. The serving cell gNB may receive, from the UE, a measurement report that indicates a signal quality measurement based on the CSI-RS from the neighbor cell gNB.

### PRIORITY CLAIM

This application claims priority to U.S. Provisional Patent Application Ser. No. 62/545,238, filed Aug. 14, 2017, which is incorporated herein by reference in its entirety.

### TECHNICAL FIELD

Embodiments pertain to wireless communications. Some embodiments relate to wireless networks including 3GPP (Third Generation Partnership Project) networks, 3GPP LTE (Long Term Evolution) networks, and 3GPP LTE-A (LTE Advanced) networks. Some embodiments relate to Fifth Generation (5G) networks. Some embodiments relate to New Radio (NR) networks. Some embodiments relate to neighbor cell measurements. Some embodiments relate to usage of reference signals, including channel state information reference signals (CSI-RS). Some embodiments relate to measurement gaps, including techniques to configure measurement gaps.

### BACKGROUND

Base stations and mobile devices operating in a cellular network may exchange data. Various techniques may be used to improve capacity and/or performance, in some cases, including communication in accordance with new radio (NR) techniques. In an example, a mobile device at a cell edge may experience performance degradation and may benefit from a handover to another 30 cell. An overall benefit to the system may also be realized as a result of the handover. Accordingly, there is a general need for methods and systems to perform operations related to handover in these and other scenarios.

### BRIEF DESCRIPTION OF THE DRAWINGS

FIG. 1A is a functional diagram of an example network in accordance with some embodiments;

FIG. 1B is a functional diagram of another example network in accordance with some embodiments;

FIG. 2 illustrates a block diagram of an example machine in accordance with some embodiments;

FIG. 3 illustrates a user device in accordance with some aspects:

FIG. 4 illustrates a base station in accordance with some aspects;

FIG. 5 illustrates an exemplary communication circuitry according to some aspects;

FIG. 6 illustrates the operation of a method of communication in accordance with some embodiments;

FIG. 7 illustrates the operation of another method of communication in accordance with some embodiments;

FIG. 8 illustrates the operation of another method of communication in accordance with some embodiments; and

FIG. 9 illustrates example messages that may be exchanged in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

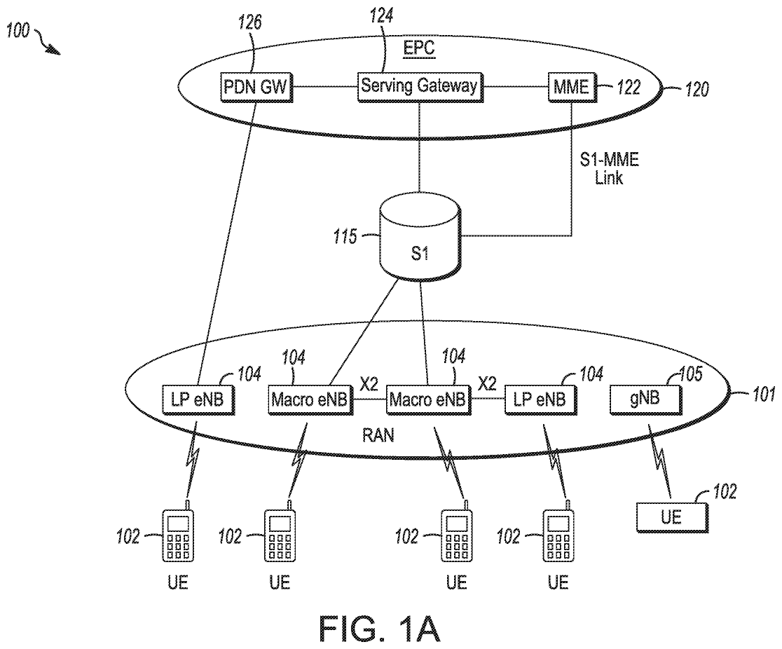

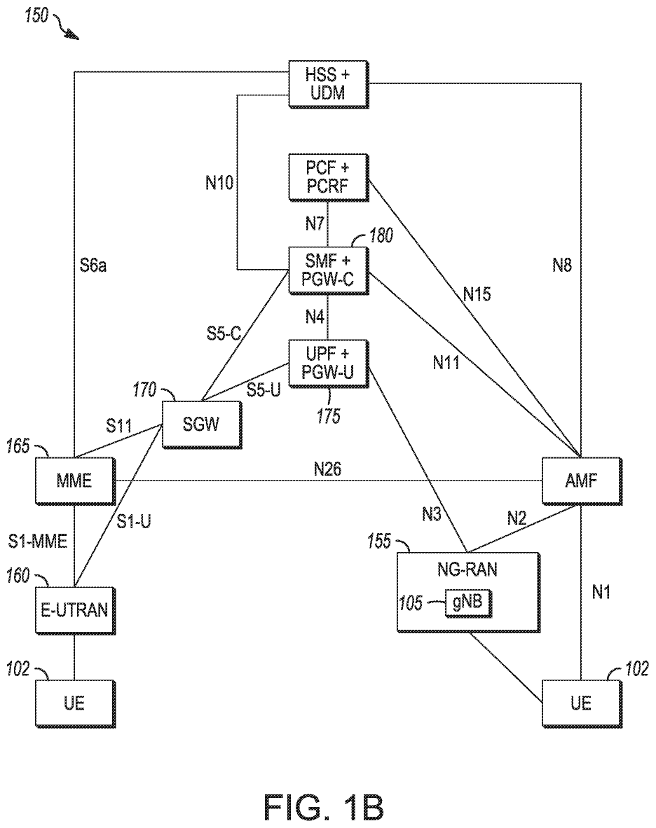

FIG. 1A is a functional diagram of an example network in accordance with some embodiments. FIG. 1B is a functional diagram of another example network in accordance with some embodiments. In some embodiments, the network 100 may be a Third Generation Partnership Project (3GPP) network. In some embodiments, the network 150 may be a 3GPP network. In a non-limiting example, the network 150 may be a new radio (NR) network. It should be noted that embodiments are not limited to usage of 3GPP networks, however, as other networks may be used in some embodiments. As an example, a Fifth Generation (5G) network may be used in some cases. As another example, a New Radio (NR) network may be used in some cases. As another example, a wireless local area network (WLAN) may be used in some cases. Embodiments are not limited to these example networks, however, as other networks may be used in some embodiments. In some embodiments, a network may include one or more components shown in FIG. 1A. Some embodiments may not necessarily include all components shown in FIG. 1A, and some embodiments may include additional components not shown in FIG. 1A. In some embodiments, a network may include one or more components shown in FIG. 1B. Some embodiments may not necessarily include all components shown in FIG. 1B, and some embodiments may include additional components not shown in FIG. 1B. In some embodiments, a network may include one or more components shown in FIG. 1A and one or more components shown in FIG. 1B. In some embodiments, a network may include one or more components shown in FIG. 1A, one or more components shown in FIG. 1B and one or more additional components.

The network 100 may comprise a radio access network (RAN) 101 and the core network 120 (e.g., shown as an evolved packet core (EPC)) coupled together through an S1 interface 115. For convenience and brevity sake, only a portion of the core network 120, as well as the RAN 101, is shown. In a non-limiting example, the RAN 101 may be an evolved universal terrestrial radio access network (E-UTRAN). In another non-limiting example, the RAN 101 may include one or more components of a New Radio (NR) network. In another non-limiting example, the RAN 101 may include one or more components of an E-UTRAN and one or more components of another network (including but not limited to an NR network).

The core network 120 may include a mobility management entity (MME) 122, a serving gateway (serving GW) 124, and packet data network gateway (PDN GW) 126. In some embodiments, the network 100 may include (and/or support) one or more Evolved Node-B's (eNBs) 104 (which may operate as base stations) for communicating with User Equipment (UE) 102. The eNBs 104 may include macro eNBs and low power (LP) eNBs, in some embodiments.

In some embodiments, the network 100 may include (and/or support) one or more Generation Node-B's (gNBs) 105. In some embodiments, one or more eNBs 104 may be configured to operate as gNBs 105. Embodiments are not limited to the number of eNBs 104 shown in FIG. 1A or to the number of gNBs 105 shown in FIG. 1A. In some embodiments, the network 100 may not necessarily include eNBs 104. Embodiments are also not limited to the connectivity of components shown in FIG. 1A.

It should be noted that references herein to an eNB 104 or to a gNB 105 are not limiting. In some embodiments, one or more operations, methods and/or techniques (such as those described herein) may be practiced by a base station component (and/or other component), including but not limited to a gNB 105, an eNB 104, a serving cell, a transmit receive point (TRP) and/or other. In some embodiments, the base station component may be configured to operate in accordance with a New Radio (NR) protocol and/or NR standard, although the scope of embodiments is not limited in this respect. In some embodiments, the base station component may be configured to operate in accordance with a Fifth Generation (5G) protocol and/or 5G standard, although the scope of embodiments is not limited in this respect.

In some embodiments, one or more of the UEs 102 and/or eNBs 104 may be configured to operate in accordance with an NR protocol and/or NR techniques. References to a UE 102, eNB 104 and/or gNB 105 as part of descriptions herein are not limiting. For instance, descriptions of one or more operations, techniques and/or methods practiced by a gNB 105 are not limiting. In some embodiments, one or more of those operations, techniques and/or methods may be practiced by an eNB 104 and/or other base station component.

In some embodiments, the UE 102 may transmit signals (data, control and/or other) to the gNB 105, and may receive signals (data, control and/or other) from the gNB 105. In some embodiments, the UE 102 may transmit signals (data, control and/or other) to the eNB 104, and may receive signals (data, control and/or other) from the eNB 104. These embodiments will be described in more detail below.

The MME 122 is similar in function to the control plane of legacy Serving GPRS Support Nodes (SGSN). The MME 122 manages mobility aspects in access such as gateway selection and tracking area list management. The serving GW 124 terminates the interface toward the RAN 101, and routes data packets between the RAN 101 and the core network 120. In addition, it may be a local mobility anchor point for inter-eNB handovers and also may provide an anchor for inter-3GPP mobility. Other responsibilities may include lawful intercept, charging, and some policy enforcement. The serving GW 124 and the MME 122 may be implemented in one physical node or separate physical nodes. The PDN GW 126 terminates an SGi interface toward the packet data network (PDN). The PDN GW 126 routes data packets between the EPC 120 and the external PDN, and may be a key node for policy enforcement and charging data collection. It may also provide an anchor point for mobility with non-LTE accesses. The external PDN can be any kind of IP network, as well as an IP Multimedia Subsystem (IMS) domain. The PDN GW 126 and the serving GW 124 may be implemented in one physical node or separated physical nodes.

In some embodiments, the eNBs 104 (macro and micro) terminate the air interface protocol and may be the first point of contact for a UE 102. In some embodiments, an eNB 104 may fulfill various logical functions for the network 100, including but not limited to RNC (radio network controller functions) such as radio bearer management, uplink and downlink dynamic radio resource management and data packet scheduling, and mobility management.

In some embodiments, UEs 102 may be configured to communicate Orthogonal Frequency Division Multiplexing (OFDM) communication signals with an eNB 104 and/or gNB 105 over a multicarrier communication channel in accordance with an Orthogonal Frequency Division Multiple Access (OFDMA) communication technique. In some embodiments, eNBs 104 and/or gNBs 105 may be configured to communicate OFDM communication signals with a UE 102 over a multicarrier communication channel in accordance with an OFDMA communication technique. The OFDM signals may comprise a plurality of orthogonal subcarriers.

The S1 interface 115 is the interface that separates the RAN 101 and the EPC 120. It may be split into two parts: the S1-U, which carries traffic data between the eNBs 104 and the serving GW 124, and the S1-MME, which is a signaling interface between the eNBs 104 and the MME 122. The X2 interface is the interface between eNBs 104. The X2 interface comprises two parts, the X2-C and X2-U. The X2-C is the control plane interface between the eNBs 104, while the X2-U is the user plane interface between the eNBs 104.

In some embodiments, similar functionality and/or connectivity described for the eNB 104 may be used for the gNB 105, although the scope of embodiments is not limited in this respect. In a non-limiting example, the S1 interface 115 (and/or similar interface) may be split into two parts: the S1-U, which carries traffic data between the gNBs 105 and the serving GW 124, and the S1-MME, which is a signaling interface between the gNBs 104 and the MME 122. The X2 interface (and/or similar interface such as Xn interface) may enable communication between eNBs 104, communication between gNBs 105 and/or communication between an eNB 104 and a gNB 105.

With cellular networks, LP cells are typically used to extend coverage to indoor areas where outdoor signals do not reach well, or to add network capacity in areas with very dense phone usage, such as train stations. As used herein, the term low power (LP) eNB refers to any suitable relatively low power eNB for implementing a narrower cell (narrower than a macro cell) such as a femtocell, a picocell, or a micro cell. Femtocell eNBs are typically provided by a mobile network operator to its residential or enterprise customers. A femtocell is typically the size of a residential gateway or smaller and generally connects to the user's broadband line. Once plugged in, the femtocell connects to the mobile operator's mobile network and provides extra coverage in a range of typically 30 to 50 meters for residential femtocells. Thus, a LP eNB might be a femtocell eNB since it is coupled through the PDN GW 126. Similarly, a picocell is a wireless communication system typically covering a small area, such as in-building (offices, shopping malls, train stations, etc.), or more recently in-aircraft. A picocell eNB can generally connect through the X2 link to another eNB such as a macro eNB through its base station controller (BSC) functionality. Thus. LP eNB may be implemented with a picocell eNB since it is coupled to a macro eNB via an X2 interface. Picocell eNBs or other LP eNBs may incorporate some or all functionality of a macro eNB. In some cases, this may be referred to as an access point base station or enterprise femtocell. In some embodiments, various types of gNBs 105 may be used, including but not limited to one or more of the eNB types described above.

In some embodiments, the network 150 may include one or more components configured to operate in accordance with one or more 3GPP standards, including but not limited to an NR standard. The network 150 shown in FIG. 1B may include a next generation RAN (NG-RAN) 155, which may include one or more gNBs 105. In some embodiments, the network 150 may include the E-UTRAN 160, which may include one or more eNBs. The E-UTRAN 160 may be similar to the RAN 101 described herein, although the scope of embodiments is not limited in this respect.

In some embodiments, the network 150 may include the MME 165. The MME 165 may be similar to the MME 122 described herein, although the scope of embodiments is not limited in this respect. The MME 165 may perform one or more operations or functionality similar to those described herein regarding the MME 122, although the scope of embodiments is not limited in this respect.

In some embodiments, the network 150 may include the SGW 170. The SGW 170 may be similar to the SGW 124 described herein, although the scope of embodiments is not limited in this respect. The SGW 170 may perform one or more operations or functionality similar to those described herein regarding the SGW 124, although the scope of embodiments is not limited in this respect.

In some embodiments, the network 150 may include component(s) and/or module(s) for functionality for a user plane function (UPF) and user plane functionality for PGW (PGW-U), as indicated by 175. In some embodiments, the network 150 may include component(s) and/or module(s) for functionality for a session management function (SMF) and control plane functionality for PGW (PGW-C), as indicated by 180. In some embodiments, the component(s) and/or module(s) indicated by 175 and/or 180 may be similar to the PGW 126 described herein, although the scope of embodiments is not limited in this respect. The component(s) and/or module(s) indicated by 175 and/or 180 may perform one or more operations or functionality similar to those described herein regarding the PGW 126, although the scope of embodiments is not limited in this respect. One or both of the components 170, 175 may perform at least a portion of the functionality described herein for the PGW 126, although the scope of embodiments is not limited in this respect.

Embodiments are not limited to the number or type of components shown in FIG. 1B. Embodiments are also not limited to the connectivity of components shown in FIG. 1B.

In some embodiments, a downlink resource grid may be used for downlink transmissions from an eNB 104 to a UE 102, while uplink transmission from the UE 102 to the eNB 104 may utilize similar techniques. In some embodiments, a downlink resource grid may be used for downlink transmissions from a gNB 105 to a UE 102, while uplink transmission from the UE 102 to the gNB 105 may utilize similar techniques. The grid may be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid correspond to one OFDM symbol and one OFDM subcarrier, respectively. The duration of the resource grid in the time domain corresponds to one slot in a radio frame. The smallest time-frequency unit in a resource grid is denoted as a resource element (RE). There are several different physical downlink channels that are conveyed using such resource blocks. With particular relevance to this disclosure, two of these physical downlink channels are the physical downlink shared channel and the physical down link control channel.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

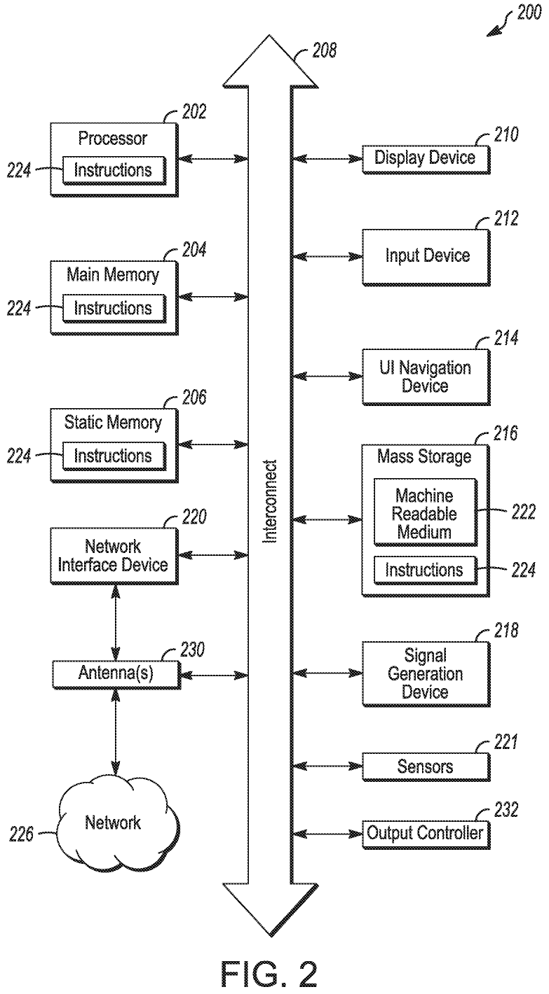

FIG. 2 illustrates a block diagram of an example machine in accordance with some embodiments. The machine 200 is an example machine upon which any one or more of the techniques and/or methodologies discussed herein may be performed. In alternative embodiments, the machine 200 may operate as a standalone device or may be connected (e.g., networked) to other machines. In a networked deployment, the machine 200 may operate in the capacity of a server machine, a client machine, or both in server-client network environments. In an example, the machine 200 may act as a peer machine in peer-to-peer (P2P) (or other distributed) network environment. The machine 200 may be a UE 102, eNB 104, gNB 105, access point (AP), station (STA), user, device, mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 200 may include a hardware processor 202 (e.g., a central processing unit (CPU), a graphics processing unit (GPU), a hardware processor core, or any combination thereof), a main memory 204 and a static memory 206, some or all of which may communicate with each other via an interlink (e.g., bus) 208. The machine 200 may further include a display unit 210, an alphanumeric input device 212 (e.g., a keyboard), and a user interface (UI) navigation device 214 (e.g., a mouse). In an example, the display unit 210, input device 212 and UI navigation device 214 may be a touch screen display. The machine 200 may additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 may include an output controller 228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 may constitute machine readable media. In some embodiments, the machine readable medium may be or may include a non-transitory computer-readable storage medium. In some embodiments, the machine readable medium may be or may include a computer-readable storage medium.

While the machine readable medium 222 is illustrated as a single medium, the term “machine readable medium” may include a single medium or multiple media (e.g., a centralized or distributed database, and/or associated caches and servers) configured to store the one or more instructions 224. The term “machine readable medium” may include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 224 may further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 220 may wirelessly communicate using Multiple User MIMO techniques. The term “transmission medium” shall be taken to include any intangible medium that is capable of storing, encoding or carrying instructions for execution by the machine 200, and includes digital or analog communications signals or other intangible medium to facilitate communication of such software.

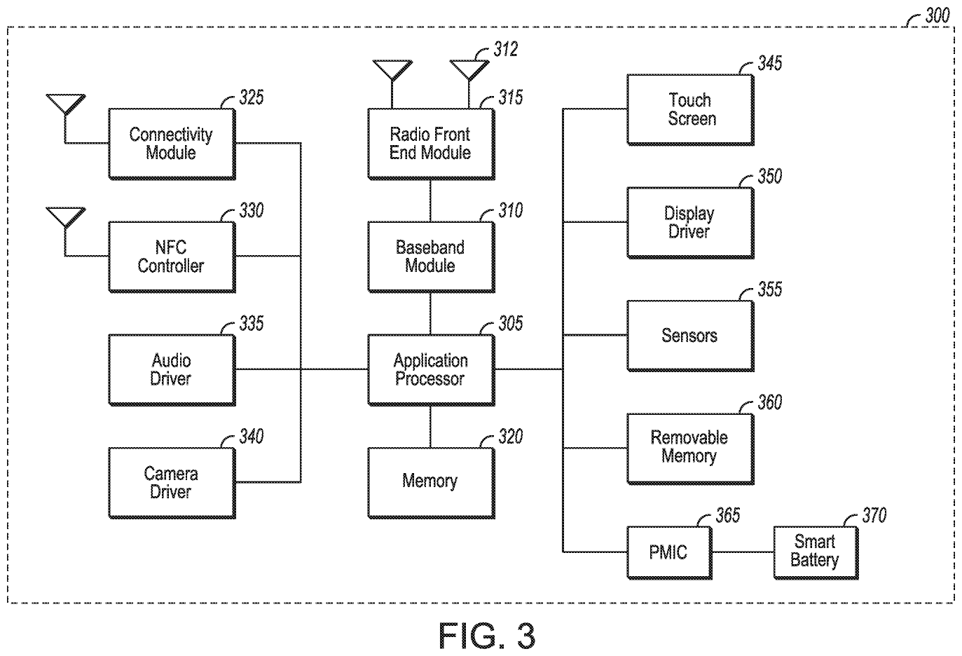

FIG. 3 illustrates a user device in accordance with some aspects. In some embodiments, the user device 300 may be a mobile device. In some embodiments, the user device 300 may be or may be configured to operate as a User Equipment (UE). In some embodiments, the user device 300 may be arranged to operate in accordance with a new radio (NR) protocol. In some embodiments, the user device 300 may be arranged to operate in accordance with a Third Generation Partnership Protocol (3GPP) protocol. The user device 300 may be suitable for use as a UE 102 as depicted in FIG. 1, in some embodiments. It should be noted that in some embodiments, a UE, an apparatus of a UE, a user device or an apparatus of a user device may include one or more of the components shown in one or more of FIGS. 2, 3, and 5. In some embodiments, such a UE, user device and/or apparatus may include one or more additional components.

In some aspects, the user device 300 may include an application processor 305, baseband processor 310 (also referred to as a baseband module), radio front end module (RFEM) 315, memory 320, connectivity module 325, near field communication (NFC) controller 330, audio driver 335, camera driver 340, touch screen 345, display driver 350, sensors 355, removable memory 360, power management integrated circuit (PMIC) 365 and smart battery 370. In some aspects, the user device 300 may be a User Equipment (UE).

In some aspects, application processor 305 may include, for example, one or more CPU cores and one or more of cache memory, low drop-out voltage regulators (LDOs), interrupt controllers, serial interfaces such as serial peripheral interface (SPI), inter-integrated circuit (I²C) or universal programmable serial interface module, real time clock (RTC), timer-counters including interval and watchdog timers, general purpose input-output (IO), memory card controllers such as secure digital/multi-media card (SD/MMC) or similar, universal serial bus (USB) interfaces, mobile industry processor interface (MIPI) interfaces and Joint Test Access Group (JTAG) test access ports.

In some aspects, baseband module 310 may be implemented, for example, as a solder-down substrate including one or more integrated circuits, a single packaged integrated circuit soldered to a main circuit board, and/or a multi-chip module containing two or more integrated circuits.

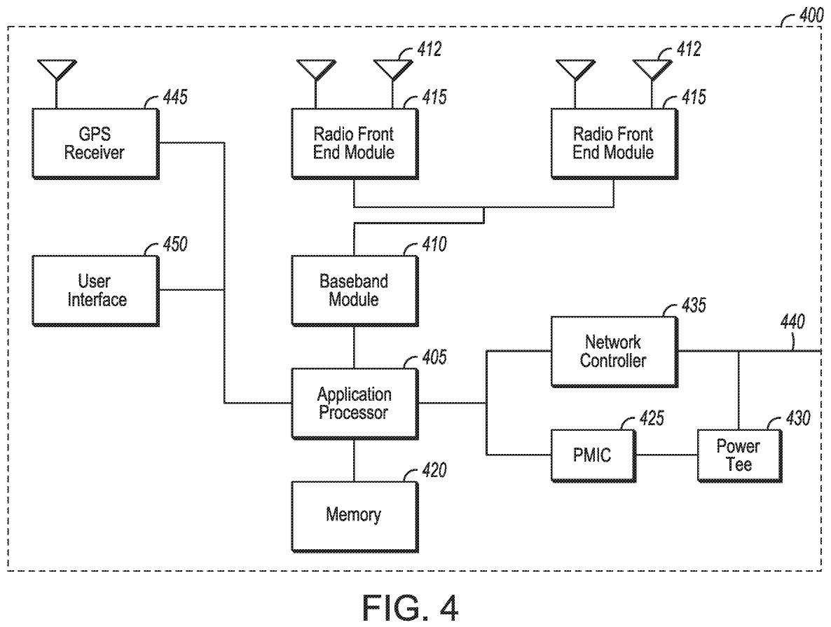

FIG. 4 illustrates a base station in accordance with some aspects. In some embodiments, the base station 400 may be or may be configured to operate as an Evolved Node-B (eNB). In some embodiments, the base station 400 may be or may be configured to operate as a Generation Node-B (gNB). In some embodiments, the base station 400 may be arranged to operate in accordance with a new radio (NR) protocol. In some embodiments, the base station 400 may be arranged to operate in accordance with a Third Generation Partnership Protocol (3GPP) protocol. It should be noted that in some embodiments, the base station 400 may be a stationary non-mobile device. The base station 400 may be suitable for use as an eNB 104 as depicted in FIG. 1, in some embodiments. The base station 400 may be suitable for use as a gNB 105 as depicted in FIG. 1, in some embodiments. It should be noted that in some embodiments, an eNB, an apparatus of an eNB, a gNB, an apparatus of a gNB, a base station and/or an apparatus of a base station may include one or more of the components shown in one or more of FIGS. 2, 4, and 5. In some embodiments, such an eNB, gNB, base station and/or apparatus may include one or more additional components.

FIG. 4 illustrates a base station or infrastructure equipment radio head 400 in accordance with an aspect. The base station 400 may include one or more of application processor 405, baseband modules 410, one or more radio front end modules 415, memory 420, power management circuitry 425, power tee circuitry 430, network controller 435, network interface connector 440, satellite navigation receiver module 445, and user interface 450. In some aspects, the base station 400 may be an Evolved Node-B (eNB), which may be arranged to operate in accordance with a 3GPP protocol, new radio (NR) protocol and/or Fifth Generation (5G) protocol. In some aspects, the base station 400 may be a generation Node-B (gNB), which may be arranged to operate in accordance with a 3GPP protocol, new radio (NR) protocol and/or Fifth Generation (5G) protocol.

In some aspects, application processor 405 may include one or more CPU cores and one or more of cache memory, low drop-out voltage regulators (LDOs), interrupt controllers, serial interfaces such as SPI, I²C or universal programmable serial interface module, real time clock (RTC), timer-counters including interval and watchdog timers, general purpose IO, memory card controllers such as SD/MMC or similar. USB interfaces, MIPI interfaces and Joint Test Access Group (JTAG) test access ports.

In some aspects, baseband processor 410 may be implemented, for example, as a solder-down substrate including one or more integrated circuits, a single packaged integrated circuit soldered to a main circuit board or a multi-chip module containing two or more integrated circuits.

In some aspects, memory 420 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magneto-resistive random access memory (MRAM) and/or a three-dimensional cross-point memory. Memory 420 may be implemented as one or more of solder down packaged integrated circuits, socketed memory modules and plug-in memory cards.

In some aspects, power management integrated circuitry 425 may include one or more of voltage regulators, surge protectors, power alarm detection circuitry and one or more backup power sources such as a battery or capacitor. Power alarm detection circuitry may detect one or more of brown out (under-voltage) and surge (over-voltage) conditions.

In some aspects, power tee circuitry 430 may provide for electrical power drawn from a network cable to provide both power supply and data connectivity to the base station 400 using a single cable. In some aspects, network controller 435 may provide connectivity to a network using a standard network interface protocol such as Ethernet. Network connectivity may be provided using a physical connection which is one of electrical (commonly referred to as copper interconnect), optical or wireless.

In some aspects, satellite navigation receiver module 445 may include circuitry to receive and decode signals transmitted by one or more navigation satellite constellations such as the global positioning system (GPS), Globalnaya Navigatsionnaya Sputnikovaya Sistema (GLONASS), Galileo and/or BeiDou. The receiver 445 may provide data to application processor 405 which may include one or more of position data or time data. Application processor 405 may use time data to synchronize operations with other radio base stations. In some aspects, user interface 450 may include one or more of physical or virtual buttons, such as a reset button, one or more indicators such as light emitting diodes (LEDs) and a display screen.

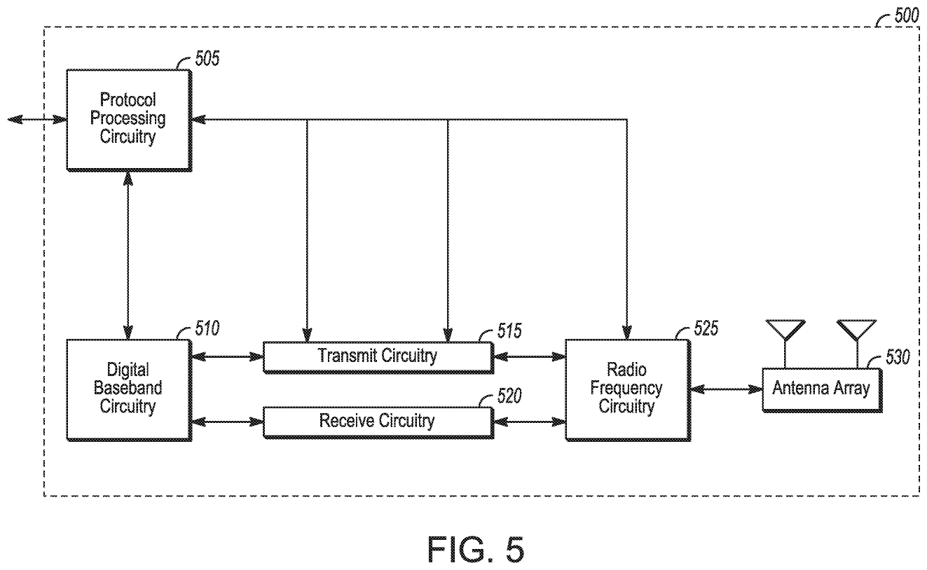

FIG. 5 illustrates an exemplary communication circuitry according to some aspects. Circuitry 500 is alternatively grouped according to functions. Components as shown in 500 are shown here for illustrative purposes and may include other components not shown here in FIG. 5. In some aspects, the communication circuitry 500 may be used for millimeter wave communication, although aspects are not limited to millimeter wave communication. Communication at any suitable frequency may be performed by the communication circuitry 500 in some aspects.

It should be noted that a device, such as a UE 102, eNB 104, gNB 105, the user device 300, the base station 400, the machine 200 and/or other device may include one or more components of the communication circuitry 500, in some aspects.

The communication circuitry 500 may include protocol processing circuitry 505, which may implement one or more of medium access control (MAC), radio link control (RLC), packet data convergence protocol (PDCP), service data adaptation protocol (SDAP), radio resource control (RRC) and non-access stratum (NAS) functions. Protocol processing circuitry 505 may include one or more processing cores (not shown) to execute instructions and one or more memory structures (not shown) to store program and data information.

The communication circuitry 500 may further include digital baseband circuitry 510, which may implement physical layer (PHY) functions including one or more of hybrid automatic repeat request (HARQ) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

The communication circuitry 500 may further include transmit circuitry 515, receive circuitry 520 and/or antenna array circuitry 530. The communication circuitry 500 may further include radio frequency (RF) circuitry 525. In an aspect of the disclosure, RF circuitry 525 may include multiple parallel RF chains for one or more of transmit or receive functions, each connected to one or more antennas of the antenna array 530.

In an aspect of the disclosure, protocol processing circuitry 505 may include one or more instances of control circuitry (not shown) to provide control functions for one or more of digital baseband circuitry 510, transmit circuitry 515, receive circuitry 520, and/or radio frequency circuitry 525

In some embodiments, processing circuitry may perform one or more operations described herein and/or other operation(s). In a non-limiting example, the processing circuitry may include one or more components such as the processor 202, application processor 305, baseband module 310, application processor 405, baseband module 410, protocol processing circuitry 505, digital baseband circuitry 510, similar component(s) and/or other component(s).

In some embodiments, a transceiver may transmit one or more elements (including but not limited to those described herein) and/or receive one or more elements (including but not limited to those described herein). In a non-limiting example, the transceiver may include one or more components such as the radio front end module 315, radio front end module 415, transmit circuitry 515, receive circuitry 520, radio frequency circuitry 525, similar component(s) and/or other component(s).

One or more antennas (such as 230, 312, 412, 530 and/or others) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, one or more of the antennas (such as 230, 312, 412, 530 and/or others) may be effectively separated to take advantage of spatial diversity and the different channel characteristics that may result.

In some embodiments, the UE 102, eNB 104, gNB 105, user device 300, base station 400, machine 200 and/or other device described herein may be a mobile device and/or portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the UE 102, eNB 104, gNB 105, user device 300, base station 400, machine 200 and/or other device described herein may be configured to operate in accordance with 3GPP standards, although the scope of the embodiments is not limited in this respect. In some embodiments, the UE 102, eNB 104, gNB 105, user device 300, base station 400, machine 200 and/or other device described herein may be configured to operate in accordance with new radio (NR) standards, although the scope of the embodiments is not limited in this respect. In some embodiments, the UE 102, eNB 104, gNB 105, user device 300, base station 400, machine 200 and/or other device described herein may be configured to operate according to other protocols or standards, including IEEE 802.11 or other IEEE standards. In some embodiments, the UE 102, eNB 104, gNB 105, user device 300, base station 400, machine 200 and/or other device described herein may include one or more of a keyboard, a display, a non-volatile memory port, multiple antennas, a graphics processor, an application processor, speakers, and other mobile device elements. The display may be an LCD screen including a touch screen.

Although the UE 102, eNB 104, gNB 105, user device 300, base station 400, machine 200 and/or other device described herein may each be illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus used by the UE 102, eNB 104, gNB 105, machine 200, user device 300 and/or base station 400 may include various components shown in FIGS. 2-5. Accordingly, techniques and operations described herein that refer to the UE 102 may be applicable to an apparatus of a UE. In addition, techniques and operations described herein that refer to the eNB 104 may be applicable to an apparatus of an eNB. In addition, techniques and operations described herein that refer to the gNB 105 may be applicable to an apparatus of a gNB.

In accordance with some embodiments, a gNB 105 may be configurable to operate as a serving cell gNB 105. The serving cell gNB 105 may transmit, to a neighbor cell gNB 105, a channel state information reference signal (CSI-RS) status request message to request timing information for CSI-RS from the neighbor cell gNB 105. The serving cell gNB 105 may receive, from the neighbor cell gNB 105, a CSI-RS status update message that indicates the timing information. The serving cell gNB 105 may determine, based on the timing information, a measurement gap to be reserved for transmission of the CSI-RS from the neighbor cell gNB 105 to a UE 102 that is served by the serving cell gNB 105. The serving cell gNB 105 may transmit, to the UE 102, control signaling that indicates the measurement gap. The serving cell gNB 105 may receive, from the UE 102, a measurement report that indicates a signal quality measurement based on the CSI-RS from the neighbor cell gNB 105. These embodiments are described in more detail below.

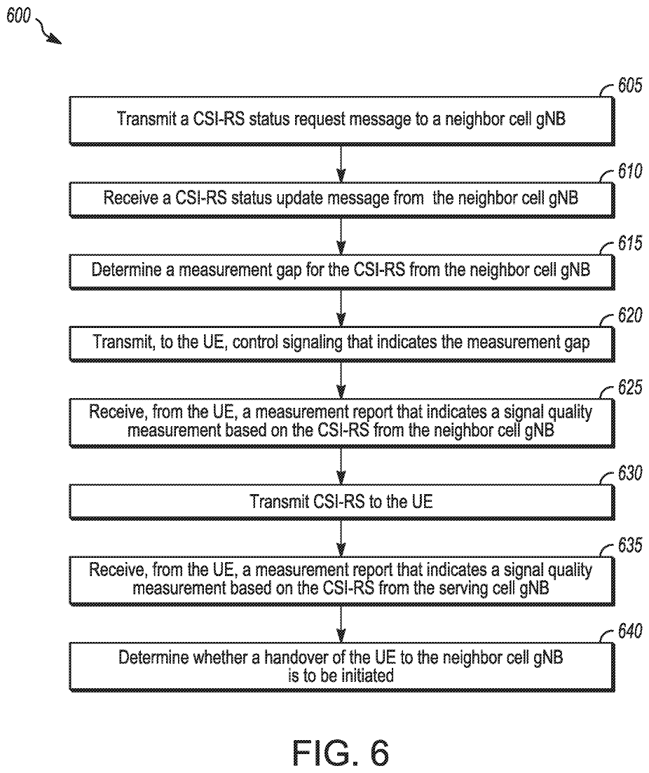

FIG. 6 illustrates the operation of a method of communication in accordance with some embodiments. It is important to note that embodiments of the method 600 may include additional or even fewer operations or processes in comparison to what is illustrated in FIG. 6. In addition, embodiments of the method 600 are not necessarily limited to the chronological order that is shown in FIG. 6. In describing the method 600, reference may be made to one or more of FIGS. 1-8, although it is understood that the method 600 may be practiced with any other suitable systems, interfaces and components.

In some embodiments, a gNB 105 may perform one or more operations of the method 600, but embodiments are not limited to performance of the method 600 and/or operations of it by the gNB 105. In some embodiments, another device (including but not limited to an eNB 104, an eNB 104 configured to operate as a gNB 105, a UE 102 and/or other device) may perform one or more operations that may be the same as, similar to and/or reciprocal to one or more of the operations of the method 600.

In some embodiments, a gNB 105 may be configurable to operate as a serving cell gNB 105, and may perform one or more operations of the method 600. The scope of embodiments is not limited to performance of the operations of the method 600 by a gNB 105 that is configurable to operate as a serving cell gNB 105, however. In some embodiments, a gNB 105 may be configurable to operate as a neighbor cell gNB 105, and may perform one or more operations that may be the same as, similar to and/or reciprocal to one or more of the operations of the method 600. In some embodiments, a gNB 105 may be configurable to operate as one or more of: a serving cell gNB 105 and a neighbor cell gNB 105. In some embodiments, a gNB 105 may perform one or more operations that may be the same as, similar to and/or reciprocal to one or more of the operations of the method 600.

In some embodiments, the gNB 105 may be arranged to operate in accordance with a New Radio (NR) standard and/or protocol, although the scope of embodiments is not limited in this respect. While the method 600 and other methods described herein may refer to eNBs 104, gNBs 105 or UEs 102 operating in accordance with 3GPP standards, 5G standards, NR standards and/or other standards, embodiments of those methods are not limited to just those eNBs 104, gNBs 105 or UEs 102 and may also be practiced on other devices, such as a Wi-Fi access point (AP) or user station (STA). In addition, the method 600 and other methods described herein may be practiced by wireless devices configured to operate in other suitable types of wireless communication systems, including systems configured to operate according to various IEEE standards such as IEEE 802.11. The method 600 may also be applicable to an apparatus of a UE 102, an apparatus of an eNB 104, an apparatus of a gNB 105 and/or an apparatus of another device described above.

It should also be noted that embodiments are not limited by references herein (such as in descriptions of the methods 600, 700, 800 and/or other descriptions herein) to transmission, reception and/or exchanging of elements such as frames, messages, requests, indicators, signals or other elements. In some embodiments, such an element may be generated, encoded or otherwise processed by processing circuitry (such as by a baseband processor included in the processing circuitry) for transmission. The transmission may be performed by a transceiver or other component, in some cases. In some embodiments, such an element may be decoded, detected or otherwise processed by the processing circuitry (such as by the baseband processor). The element may be received by a transceiver or other component, in some cases. In some embodiments, the processing circuitry and the transceiver may be included in a same apparatus. The scope of embodiments is not limited in this respect, however, as the transceiver may be separate from the apparatus that comprises the processing circuitry, in some embodiments.

In some embodiments, a gNB 105 configurable to operate as a serving cell gNB 105 may perform one or more operations of the method 600, although the scope of embodiments is not limited in this respect. In descriptions herein, references to a serving cell gNB 105 and a neighbor cell gNB 105 are not limiting. Such references may be used for clarity, in some cases. In some embodiments, a gNB 105 may be configurable to operate as one or more of: a target gNB, a source gNB, an MgNB and an SgNB. 105.

At operation 605, the serving cell gNB 105 may transmit a channel state information reference signal (CSI-RS) status request message to a neighbor cell gNB 105. In some embodiments, the serving cell gNB 105 may transmit the CSI-RS status request message to request transmission status of CSI-RS by the neighbor cell gNB 105, although the scope of embodiments is not limited in this respect. In some embodiments, the serving cell gNB 105 may transmit the CSI-RS status request message to request timing information of CSI-RS from the neighbor cell gNB 105, although the scope of embodiments is not limited in this respect. In some embodiments, the serving cell gNB 105 may transmit the CSI-RS status request message to request information related to transmission of CSI-RS from the neighbor cell gNB 105, although the scope of embodiments is not limited in this respect. In some embodiments, the serving cell gNB 105 may transmit the CSI-RS status request message to indicate an intention of the serving cell gNB 105 to configure a measurement gap for transmission of CSI-RS by the neighbor cell gNB 105 to a UE 102 that is served by the serving cell gNB 105, although the scope of embodiments is not limited in this respect.

In some embodiments, the CSI-RS status request message may indicate a plurality of UEs 102 served by the serving cell gNB 105. The CSI-RS status request message may indicate a request for per-UE transmissions of a plurality of CSI-RSs by the neighbor cell gNB 105 to the plurality of UEs 105. In a non-limiting example, the per-UE transmissions may be in accordance with: different frequency resources of a sub-frame for at least some of the per-UE transmissions, or different transmission directions for at least some of the per-UE transmissions.

In some embodiments, the CSI-RS status request message may indicate a request for transmission status of multiple CSI-RSs by the neighbor cell gNB 105. In some embodiments, the CSI-RS status request message may indicate a request for transmission of multiple CSI-RSs by the neighbor cell gNB 105. In some embodiments, the CSI-RS status request message may indicate a request for timing information (and/or other information) related to transmission of multiple CSI-RSs by the neighbor cell gNB 105. In some embodiments, the CSI-RS status request message may indicate one or more of: a plurality of frequency ranges in which the serving cell gNB 105 requests transmission of CSI-RSs by the neighbor cell gNB 105; a plurality of neighbor cells for which the serving cell gNB 105 requests transmission status of the multiple CSI-RSs by the neighbor cell gNB 105; and/or other information. The plurality of neighbor cells may be supported by the neighbor cell gNB 105.

In some embodiments, the CSI-RS status request message may indicate a request for transmission of multiple CSI-RSs by the neighbor cell gNB 105 to a plurality of UEs 102. The CSI-RS status request message may indicate, on a per-UE basis, one or more of: one or more frequency ranges in which the serving cell gNB 105 requests transmission of CSI-RSs by the neighbor cell gNB 105; one or more neighbor cells for which the serving cell gNB 105 requests transmission of the multiple CSI-RSs by the neighbor cell gNB 105, wherein the plurality of neighbor cells may be supported by the neighbor cell; and/or other information.

In some embodiments, the CSI-RS status request message may indicate a request for transmission status of multiple CSI-RSs in a plurality of neighbor cells supported by the neighbor cell gNB 105. In some embodiments, the CSI-RS status request message may indicate a request for timing information (and/or other information) related to transmission of multiple CSI-RSs in a plurality of neighbor cells supported by the neighbor cell gNB 105. In some embodiments, the CSI-RS status request message may indicate, on a per-cell basis for the plurality of neighbor cells, one or more frequency ranges in which the serving cell gNB 105 requests transmission of CSI-RSs by the neighbor cell gNB 105.

In some embodiments, the CSI-RS status request message may indicate a requested periodicity of the CSI-RS from the neighbor cell gNB 105.

In some embodiments, the CSI-RS status request message may be transmitted to the neighbor cell gNB 105 on an Xn interface, although the scope of embodiments is not limited in this respect.

The CSI-RS status request message may be included in a 3GPP standard. NR standard and/or other standard, although the scope of embodiments is not limited in this respect. Embodiments are not limited to usage of the CSI-RS status request message in operations described herein (such as 605 and/or other), as any suitable message may be used. In some embodiments, a CSI-RS configuration request message (which may be included in a 3GPP standard, NR standard and/or other standard) may be transmitted by the serving cell gNB 105 to the neighbor cell gNB 105. One or more elements (such as information, parameters, requests and/or other) of the CSI-RS configuration request message may be the same as or similar to one or more elements of the CSI-RS status request message, in some embodiments.

At operation 610, the serving cell gNB 105 may receive a CSI-RS status update message from the neighbor cell gNB 105. In some embodiments, the CSI-RS status update message may be transmitted in response to the CSI-RS status request message, although the scope of embodiments is not limited in this respect.

In some embodiments, the CSI-RS status update message may include timing information for the CSI-RS from the neighbor cell gNB. The timing information may include one or more of: a periodicity of the CSI-RS from the neighbor cell gNB 105, a start sub-frame of the CSI-RS from the neighbor cell gNB 105, an end sub-frame of the CSI-RS from the neighbor cell gNB 105, a sub-frame offset with respect to a system frame number (SFN) of the CSI-RS from the neighbor cell gNB 105 and/or other information.

In a non-limiting example, the CSI-RS status update message may include a parameter that indicates a periodicity of the CSI-RS from the neighbor cell gNB 105. The periodicity may be one of 5, 10, 20, 40, and 80 milliseconds. The serving cell gNB 105 may encode the control signaling to further indicate the periodicity of the CSI-RS from the neighbor cell gNB 105. Embodiments are not limited by the example values of the periodicity given above, as any suitable values may be used.

In some embodiments, the timing information of the CSI-RS status update message may be included in a CSI-RS resource information element (IE).

In some embodiments, the CSI-RS status update message may be received from the neighbor cell gNB 105 on the Xn interface, although the scope of embodiments is not limited in this respect.

The CSI-RS status update message may be included in a 3GPP standard, NR standard and/or other standard, although the scope of embodiments is not limited in this respect. Embodiments are not limited to usage of the CSI-RS status update message in operations described herein (such as 610 and/or other), as any suitable message may be used. In some embodiments, a CSI-RS configuration response message (which may be included in a 3GPP standard, NR standard and/or other standard) may be transmitted by the neighbor cell gNB 105 to the serving cell gNB 105. One or more elements (such as information, parameters, requests and/or other) of the CSI-RS configuration response message may be the same as or similar to one or more elements of the CSI-RS status update message, in some embodiments.

At operation 615, the serving cell gNB 105 may determine a measurement gap. In some embodiments, the serving cell gNB 105 may determine the measurement gap for the CSI-RS from the neighbor cell gNB 105 for a UE 102 that is served by the serving cell gNB 105, although the scope of embodiments is not limited in this respect. In some embodiments, the measurement gap may be reserved for the CSI-RS from the neighbor cell gNB 105. In some embodiments, the measurement gap may be allocated for the CSI-RS from the neighbor cell gNB 105.

In some embodiments, the serving cell gNB 105 may determine the measurement gap based at least partly on the timing information.

In some embodiments, the serving cell gNB 105 may determine information related to the measurement gap. Examples of such information include, but are not limited to, a start sub-frame and/or end sub-frame of the measurement gap, a start time and/or end time of the measurement gap, a duration of the measurement gap, a periodicity of the measurement gap, an offset between the measurement gap and another time (such as a start of a frame, start of a system frame, a reference time and/or other time).

At operation 620, the serving cell gNB 105 may transmit, to the UE 102, control signaling that indicates the measurement gap. In some embodiments, the control signaling may include information related to the measurement gap, including but not limited to information described regarding operation 615.

In some embodiments, the serving cell gNB 105 may refrain from transmission of signals during the measurement gap, although the scope of embodiments is not limited in this respect.

At operation 625, the serving cell gNB 105 may receive, from the UE 102, a measurement report that indicates a signal quality measurement. In some embodiments, the signal quality measurement may be based on reception, at the UE 102, of the CSI-RS transmissions from the neighbor cell gNB 105. In some embodiments, operation 625 may be performed before operation 605 to determine the information to be requested in the CSI-RS status request message such as a list of neighbor cells and/or frequency ranges.

Example signal quality measurements (for operation 625 and/or other operations) include, but are not limited to, signal-to-noise ratio (SNR), reference signal received power (RSRP), reference signal received quality (RSRQ), and received signal strength indicator (RSSI).

Embodiments are not limited to usage of measurement reports. For instance, in operation 625 and/or other operations, the serving cell gNB 105 may receive a signal quality measurement in an element (such as a message, report and/or other) that may not necessarily be a measurement report.

At operation 630, the serving cell gNB 105 may transmit CSI-RS to the UE 102. At operation 635, the serving cell gNB 105 may receive, from the UE 102, a measurement report that indicates a signal quality measurement based on the CSI-RS from the serving cell gNB 105. In some embodiments, the signal quality measurement of operation 635 may be based on reception, at the UE 102, of the CSI-RS transmissions from the serving cell gNB 105. In some embodiments, operation 630 and/or 635 may be performed before operation 605.

Embodiments are not limited to usage of separate reports for the signal quality measurements described above. In a non-limiting example, a measurement report may indicate a first signal quality measurement based on first CSI-RS from the neighbor cell gNB 105 and may further indicate a second signal quality measurement based on second CSI-RS from the serving cell gNB 105. In addition, the example may be extended to measurement reports that indicate more than two signal quality measurements.

In some embodiments, the CSI-RS transmitted to the UE 102 by the serving cell gNB 105 may be transmitted in another measurement gap (different from the measurement gap described in operations 615-620), although the scope of embodiments is not limited in this respect.

At operation 640, the serving cell gNB 105 may determine whether a handover of the UE 102 to the neighbor cell gNB 105 is to be initiated. In some embodiments, the serving cell gNB 105 may determine whether to initiate the handover of the UE 102 to the neighbor cell gNB 105. In some embodiments, the serving cell gNB 105 may determine whether to initiate the handover of the UE 102 and a different neighbor cell gNB 105.

In some embodiments, the serving cell gNB 105 may determine whether to initiate the handover of the UE 102 based on one or more of: a signal quality measurement from the UE 102 based on CSI-RS from the neighbor cell gNB 105, a signal quality measurement from the UE 102 based on CSI-RS from the serving cell gNB 105, one or more other signal quality measurements and/or other factors. For instance, a comparison between signal quality measurements may be performed.

In a non-limiting example, the handover may be initiated if the signal quality measurement from the UE 102 based on CSI-RS from the neighbor cell gNB 105 is greater than signal quality measurement from the UE 102 based on CSI-RS from the serving cell gNB 105. In another non-limiting example, the handover may be initiated if: the signal quality measurement from the UE 102 based on CSI-RS from the neighbor cell gNB 105 is greater than signal quality measurement from the UE 102 based on CSI-RS from the serving cell gNB 105; and the signal quality measurement from the UE 102 based on CSI-RS from the neighbor cell gNB 105 is greater than a threshold. In another non-limiting example, the handover may be initiated if the signal quality measurement from the UE 102 based on CSI-RS from the neighbor cell gNB 105 is greater than a threshold.

In another non-limiting example, the neighbor cell gNB 105 may transmit a first CSI-RS to the UE 102. The UE 102 may determine a first signal quality measurement based at least partly on the first CSI-RS. The UE 102 may transmit a first measurement report that indicates the first signal quality measurement. The serving cell gNB 105 may transmit a second CSI-RS to the UE 102. The UE 102 may determine a second signal quality measurement based at least partly on the second CSI-RS. The UE 102 may transmit a second measurement report that indicates the second signal quality measurement. The embodiments are not necessarily limited to the chronological order described herein. The serving cell gNB 105 may determine, based at least partly on the first and second signal quality measurements or based on signal quality measurement from the neighbor cell gNB, whether a handover of the UE 102 to the neighbor cell gNB is to be initiated. In some embodiments, the serving cell gNB 105 may determine whether a handover of the UE 102 to the neighbor cell gNB is to be initiate based at least partly on one or more of: the first signal quality measurement, the second signal quality measurement, one or more signal quality measurements from the neighbor cell gNB 105 and/or other information.

It should be noted that operations may be described in terms of single signal quality measurements, but such descriptions are not limiting. In some embodiments, one or more operations may be extended to include multiple signal quality measurements per measurement report, average signal quality measurements based on multiple signal quality measurements, and/or other. For instance, the UE 102 may determine multiple signal quality measurements based on multiple CSI-RSs received from the neighbor cell in different measurement gaps. The UE 102 may perform one or more of: report the multiple signal quality measurements, report one or more values (such as an average, maximum, minimum and/or other) based on the multiple signal quality measurements, report multiple signal quality measurements for CSI-RSs from multiple neighbor cell gNBs 105, report multiple signal quality measurements for CSI-RSs in multiple frequency ranges, and/or other. The serving cell gNB 105 may determine whether to initiate a handover based on multiple signal quality measurements and/or other information.

One or more of the messages described herein may be included in a standard and/or protocol, including but not limited to Third Generation Partnership Project (3GPP), 3GPP Long Term Evolution (LTE), Fourth Generation (4G), Fifth Generation (5G), New Radio (NR) and/or other. The scope of embodiments is not limited to usage of elements that are included in standards, however.

In some embodiments, an apparatus of a gNB 105 (including but not limited to a serving cell gNB 105) may comprise memory. The memory may be configurable to store information that identifies the measurement gap. The memory may store one or more other elements and the apparatus may use them for performance of one or more operations. The apparatus may include processing circuitry, which may perform one or more operations (including but not limited to operation(s) of the method 600 and/or other methods described herein). The processing circuitry may include a baseband processor. The baseband circuitry and/or the processing circuitry may perform one or more operations described herein, including but not limited to encoding of the CSI status request message. The apparatus may include a transceiver to transmit the CSI status request message. The transceiver may transmit and/or receive other blocks, messages and/or other elements.

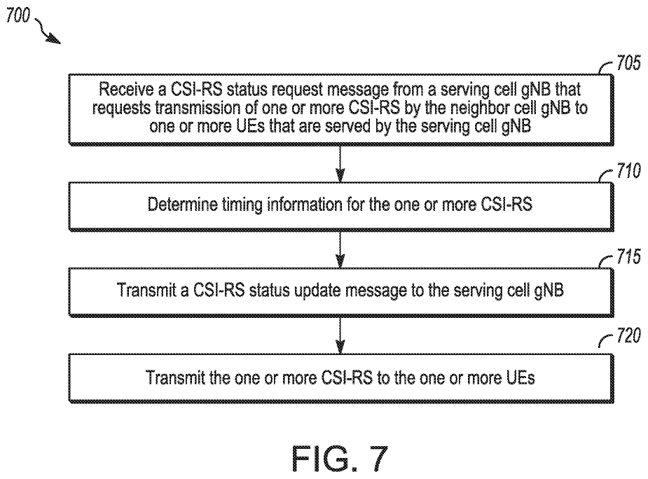

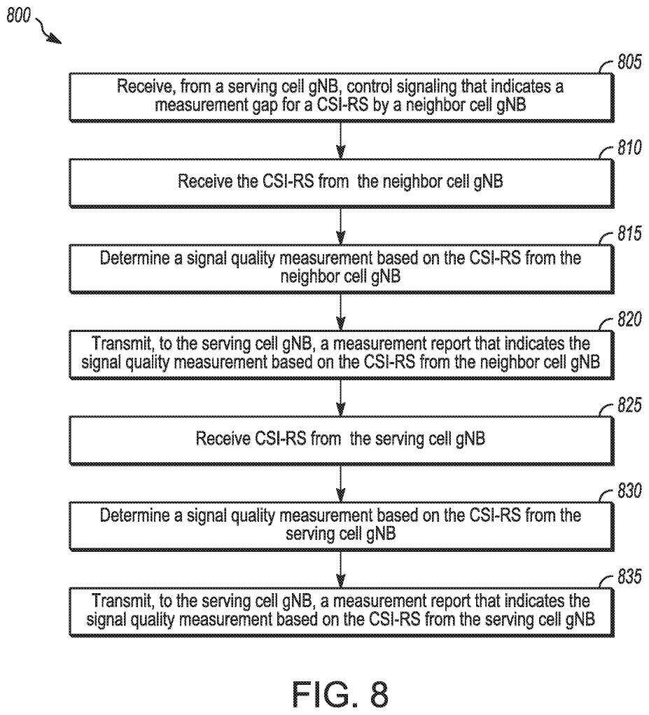

FIG. 7 illustrates the operation of another method of communication in accordance with some embodiments. FIG. 8 illustrates the operation of another method of communication in accordance with some embodiments. Embodiments of the methods 700 and 800 may include additional or even fewer operations or processes in comparison to what is illustrated in FIGS. 7-8 and embodiments of the methods 700, 800 are not necessarily limited to the chronological order that is shown in FIGS. 7-8. In descriptions of the methods 700, 800, reference may be made to one or more of the figures described herein, although it is understood that the methods 700, 800 may be practiced with any other suitable systems, interfaces and components. In addition, embodiments of the methods 700, 800 may be applicable to UEs 102, eNBs 104, gNBs 105, APs, STAs and/or other wireless or mobile devices. The methods 700, 800 may also be applicable to an apparatus of a UE 102, eNB 104, gNB 105 and/or other device described above.

In some embodiments, a gNB 105 may perform one or more operations of the method 700, but embodiments are not limited to performance of the method 700 and/or operations of it by the gNB 105. In some embodiments, another device (including but not limited to an eNB 104, an eNB 104 configured to operate as a gNB 105, a UE 102) may perform one or more operations that may be the same as, similar to and/or reciprocal to one or more of the operations of the method 700. In some embodiments, a gNB 105 may be configurable to operate as a neighbor cell gNB 105, and may perform one or more operations of the method 700. The scope of embodiments is not limited to performance of the operations of the method 700 by a gNB 105 that is configurable to operate as a neighbor cell gNB 105, however. In some embodiments, a gNB 105 may be configurable to operate as a serving cell gNB 105, and may perform one or more operations that may be the same as, similar to and/or reciprocal to one or more of the operations of the method 700. In some embodiments, a gNB 105 may be configurable to operate as one or more of: a serving cell gNB 105 and neighbor cell gNB 105. In some embodiments, a gNB 105 may perform one or more operations that may be the same as, similar to and/or reciprocal to one or more of the operations of the method 700.

In some embodiments, a UE 102 may perform one or more operations of the method 80X), but embodiments are not limited to performance of the method 800 and/or operations by the UE 102. In some embodiments, another device (including but not limited to a gNB 105, an eNB 104, an eNB 104 configured to operate as a gNB 105 and/or other device) may perform one or more operations that may be the same as, similar to and/or reciprocal to one or more of the operations of the method 800.

It should be noted that one or more operations of one of the methods 600, 700, 800 may be the same as, similar to and/or reciprocal to one or more operations of the other methods. For instance, an operation of the method 600 may be the same as, similar to and/or reciprocal to an operation of the method 700, in some embodiments. In a non-limiting example, an operation of the method 600 may include transmission of an element (such as a frame, block, message and/or other) from the serving cell gNB 105 to the neighbor cell gNB 105, and an operation of the method 700 may include reception of a same element (and/or similar element) from the serving cell gNB 105 by the neighbor cell gNB 105. In some cases, descriptions of operations and techniques described as part of one of the methods 600, 700, 800 may be relevant to one or more of the other methods.

In addition, previous discussion of various techniques and concepts may be applicable to one or more of the methods 700, 800 in some cases, including but not limited to serving cell gNB 105, neighbor cell gNB 105, CSI-RSs, signal quality measurements, measurement reports, measurement gaps, handover, messages (including but not limited to messages described regarding the method 600) and/or other. In addition, the examples shown in one or more of the figures may also be applicable, in some cases, although the scope of embodiments is not limited in this respect.

At operation 705, the neighbor cell gNB 105 may receive a CSI-RS status request message from a serving cell gNB 105 that requests transmission of one or more CSI-RS by the neighbor cell gNB 105 to one or more UEs 102 that are served by the serving cell gNB 105. At operation 710, the neighbor cell gNB 105 may determine timing information for the one or more CSI-RSs. At operation 715, the neighbor cell gNB 105 may transmit a CSI-RS status update message to the serving cell gNB 105. At operation 720, the neighbor cell gNB 105 may transmit the one or more CSI-RS to the one or more UEs 102.

In some embodiments, the neighbor cell gNB 105 may receive, from a serving cell gNB 105, a channel state information reference signal (CSI-RS) status request message to request transmission of CSI-RSs by the neighbor cell gNB 105 to a plurality of UEs 102 served by the serving cell gNB 105. The neighbor cell gNB 105 may determine timing information for transmission of the CSI-RSs. The neighbor cell gNB 105 may transmit, to the serving cell gNB 105, a CSI-RS status update message that indicates the timing information. The neighbor cell gNB 105 may transmit the CSI-RSs to the UEs 102. The CSI-RSs for at least some of the UEs may be different. The neighbor cell gNB 105 may encode the CSI-RSs for per-UE transmissions in accordance with: different frequency resources of a sub-frame for at least some of the per-UE transmissions, or different transmission directions for at least some of the per-UE transmissions.

In some embodiments, the neighbor cell gNB 105 may determine a periodicity for the CSI-RSs. In a non-limiting example, the neighbor cell gNB 105 may select a periodicity for the CSI-RSs as one of 5, 10, 20, 40, and 80 milliseconds. Embodiments are not limited to these example values, as any suitable values may be used. The neighbor cell gNB 105 may encode the CSI-RS status update message to indicate the periodicity.

In some embodiments, an apparatus of a gNB 105 (including but not limited to a neighbor cell gNB 105) may comprise memory. The memory may be configurable to store information that identifies the measurement gap. The memory may store one or more other elements and the apparatus may use them for performance of one or more operations. The apparatus may include processing circuitry, which may perform one or more operations (including but not limited to operation(s) of the method 700 and/or other methods described herein). The processing circuitry may include a baseband processor. The baseband circuitry and/or the processing circuitry may perform one or more operations described herein, including but not limited to decoding of the CSI status request message. The apparatus may include a transceiver to receive the CSI status request message. The transceiver may transmit and/or receive other blocks, messages and/or other elements.

At operation 805, the UE 102 may receive, from a serving cell gNB 105, control signaling that indicates a measurement gap for a CSI-RS by a neighbor cell gNB 105. At operation 810, the UE 102 may receive the CSI-RS from the neighbor cell gNB 105. At operation 815, the UE 102 may determine a signal quality measurement based on the CSI-RS from the neighbor cell gNB 105. At operation 820, the UE 102 may transmit, to the serving cell gNB 105, a measurement report that indicates the signal quality measurement based on the CSI-RS from the neighbor cell gNB 105. At operation 825, the UE 102 may receive CSI-RS from the serving cell gNB 105. At operation 830, the UE 102 may determine a signal quality measurement based on the CSI-RS from the serving cell gNB 105. At operation 835, the UE 102 may transmit, to the serving cell gNB 105, a measurement report that indicates the signal quality measurement based on the CSI-RS from the serving cell gNB 105.

In some embodiments, the UE 102 may receive, from a serving cell gNB 105, control signaling that indicates a measurement gap during which the UE 102 is to receive a CSI-RS from a neighbor cell gNB 105. The UE 102 may determine a signal quality measurement based on reception of the CSI-RS from the neighbor cell gNB 105 during the measurement gap. The UE 102 may refrain from reception of signals from the serving cell gNB 105 during the measurement gap. The UE 102 may transmit, to the serving cell gNB 105, a measurement report that includes the signal quality measurement.

In some embodiments, the UE 102 may determine a first signal quality measurement based on a first CSI-RS from the neighbor cell gNB 105. The UE 102 may transmit a first measurement report that includes the first signal quality measurement. The UE 102 may determine a second signal quality measurement based on reception of a second CSI-RS from the serving cell gNB 105. The UE 102 may transmit, to the serving cell gNB 105, a second measurement report that includes the second signal quality measurement. Embodiments are not necessarily limited to the chronological order described herein. Embodiments are not limited to usage of separate reports, however, as one measurement report may include both the first and the second signal quality measurements, in some embodiments.

In some embodiments, the control signaling may further indicate a periodicity of the CSI-RS. In a non-limiting example, the periodicity may be one of 5, 10, 20, 40, and 80 milliseconds. Examples are not limited by these example values, as any suitable values may be used.

In some embodiments, the UE 102 may decode multiple CSI-RSs received from the neighbor cell gNB 105 in accordance with the periodicity.

In some embodiments, an apparatus of a UE 102 may comprise memory. The memory may be configurable to store information that identifies the measurement gap. The memory may store one or more other elements and the apparatus may use them for performance of one or more operations. The apparatus may include processing circuitry, which may perform one or more operations (including but not limited to operation(s) of the method 700 and/or other methods described herein). The processing circuitry may include a baseband processor. The baseband circuitry and/or the processing circuitry may perform one or more operations described herein, including but not limited to decoding of control signaling. The apparatus may include a transceiver to receive the control signaling. The transceiver may transmit and/or receive other blocks, messages and/or other elements.

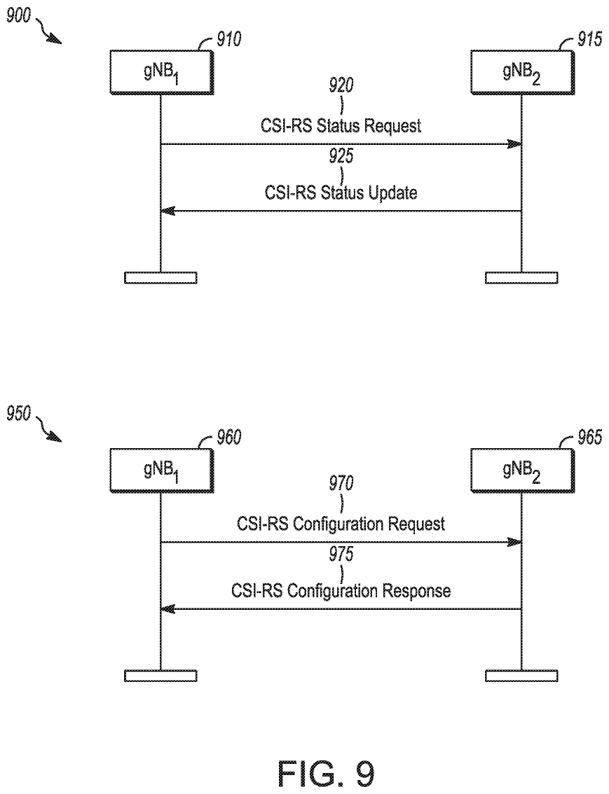

FIG. 9 illustrates example messages that may be exchanged in accordance with some embodiments. It should be noted that the examples shown in FIG. 9 may illustrate some or all of the concepts and techniques described herein in some cases, but embodiments are not limited by the examples. For instance, embodiments are not limited by the name, number, type, size, ordering, arrangement and/or other aspects of the operations, messages, gNBs 105, UEs 102, cells and other elements as shown in FIG. 9. Although some of the elements shown in the examples of FIG. 9 may be included in a 3GPP LTE standard, 5G standard, NR standard and/or other standard, embodiments are not limited to usage of such elements that are included in standards.

In some embodiments, a serving cell may configure a measurement gap (a gap during which no transmission and reception happens) for the UE 102, so that the UE 102 may measure signal qualities (such as signal qualities for CSI-RS) of serving cell and neighboring cells in same or different frequency. In a NR protocol, the measurement may gap may be aligned with the timing of CSI-RS sent from the neighboring cells, taking into account the transmission/reception status of the UE 102 to the serving cell. For this to occur, a gNB 105 that controls the serving cell may coordinate with a peer gNB 105 that controls the neighboring cell(s). The gNBs 105 may exchange information over an Xn interface regarding when CSI-RS will be sent, so that the serving cell may configure the measurement gap for the UE 102.

In some embodiments, one or more information elements (IEs) and/or message structure(s) may be used to support measurement gap coordination between gNBs 105 over the Xn interface. This may enable a gNB 105 that control the serving cell to receive the relevant CSI-RS transmission status (of interests) from a peer gNB 105 that controls the neighboring cells in order to configure an appropriate measurement gap for the UE 102. In some embodiments, exchanging of the IEs and/or messages may also enable peer gNBs 105 to adapt the CSI-RS transmission timing over Xn interface in a distributed way.

In some embodiments a CSI-RS status request message and/or CSI-RS status update message may be exchanged between gNBs 105. Referring to example 900 in FIG. 9, gNB1 910 (which may be the gNB 105 that controls the serving cell) may send the CSI-RS status request message 920 to request to gNB2 915 (which may be the peer gNB 105 that controls the neighboring cells) to provide the relevant CSI-RS status of interests. In addition, gNB2 915 may respond with the CSI-RS status update message 925.

In some embodiments, the CSI-RS status request message 920 may include one or more of: a measurement Xn-AP ID for gNB1 910; one or more configurations per UE 102 (including but not limited to a list of configurations per UE 102); and/or other. In some embodiments, a configuration for a UE 102 may include one or more of: a gNB1 UE Xn-AP ID; an NR Cell Global Identity of the serving cell; one or more frequencies (including but not limited to a list of frequencies) on which the serving cell requests transmission of CSI-RS by gNB2 915 for the UE 102 (this includes, but is not limited to, cases in which gNB2 915 serves multiple cells on multiple frequencies); one or more cell IDs (including but not limited to a list of cell IDs) for which the serving cell requests CSI-RS transmission for the UE 102; an indication of how often (how frequent) the serving cell would like to have CSI-RS measurement for these cells; and/or other.

In some embodiments, the CSI-RS status request message 920 may include one or more of: a measurement Xn-AP ID for gNB1 910; one or more configurations per serving cell (including but not limited to a list of configurations per serving cell); and/or other. In some embodiments, a configuration for a serving cell may include one or more of: an NR Cell Global Identity of the serving cell; one or more frequencies (including but not limited to a list of frequencies) on which the serving cell is interested in CSI-RS transmission (this includes, but is not limited to, cases in which gNB2 915 serves multiple cells on multiple frequencies); one or more cell IDs (including but not limited to a list of cell IDs) for which the serving cell requests CSI-RS measurement(s); an indication of how often (how frequent) the serving cell would like to have CSI-RS measurement for these cells; and/or other.

In some embodiments, the gNB2 915 may transmit a CSI-RS status update message 925. In some embodiments, the gNB2 915 may transmit the CSI-RS status update message 925 upon receipt of the CSI-RS status request message 920, although the scope of embodiments is not limited in this respect. In some embodiments, the CSI-RS status update message 925 may include one or more of: a Measurement Xn-AP ID of gNB1 910, a measurement Xn-AP ID of gNB2 915; one or more configurations per measured cell (including but not limited to a list of configurations per measured cell); one or more configurations per cell for which the request cannot be performed (including but not limited to a list of configurations per cell for which the request cannot be performed); and/or other.

In some embodiments, a configuration for a measured cell may include one or more of: an NR Cell Global Identity; a frequency of the measured cell; a CSI-RS Resource Information IE of the measured cell (which may include one or more of periodicity, start and end subframe/time, offset, and/or other); and/or other. In some embodiments, this information may be included per UE 102 (including but not limited to a list per UE) in the measured cell.

In some embodiments, a configuration per cell for which the request cannot be performed may include one or more of: an NR Cell Global Identity; a frequency of the cell; a reason (such as a cause value) why the request cannot be performed; and/or other.

In some embodiments, the CSI-RS Resource Information IE may include information related to the timing for transmission of the CSI-RS (such as a start time offset with respect to SFN, periodicity, time resources, frequency resources and/or other). This information may be different per UE 102 in some cases, although the scope of embodiments is not limited in this respect. In some embodiments, the information related to the CSI-RS transmission timing may be expressed by a standardized pattern. The standardized pattern may be associated with a specific pattern ID, in some embodiments.

The table below illustrates an exemplary structure of the CSI-RS Resource Information IE. Embodiments are not limited to the type, name, ordering, presence (such as mandatory or optional for a standard), range and/or other aspect of the parameters shown in the table. In some embodiments, the CSI-RS Resource Information IE may not necessarily include all parameters shown. In some embodiments, the CSI-RS Resource Information IE may include one or more parameters not shown in the table below.

| IE/Group Name | Presence | Range |
|---|---|---|
| CSI-RS Report per Cell | | 1 . . . <maxUEReport> |
| >gNB2 Xn-AP UE ID | M | |
| >CSI-RS Report per CSI-RS | | 1 . . . <maxCSIRSProcess> |
| Process | | |
| >>CSI-RS Process Index | M | |
| >>CSI-RS Report per CSI-RS | | 1 . . . <maxCSIRSReport> |
| Process Item | | |
| >>>Start Subframe Time | M | |
| >>>End Subframe Time | M | |
| >>>Offset | M | |
| >>>SFN | M | |
| >>>Periodicity | M | |
| >>>CSI-RS Pattern ID | O | |
| >>>RI | O | |
| >>>Wideband CQI | O | |
| >>>Subband Size | O | |
| >>>Subband CQI List | | 0 . . . <maxSubband> |
| >>>>Subband CQI | O | |
| >>>>Subband Index | O | |

In some embodiments, based at least partly on received information from peer gNBs controlling the neighboring cells (including but not limited to information described above and/or information included in the example CSI-RS Resource Information IE shown above), the serving cell may configure the measurement gap for the UE 102.

In some embodiments, gNBs 105 may exchange a CSI-RS Configuration Request message and/or CSI-RS Configuration Response message.

In some embodiments, the gNB 105 that controls the serving cell may provide, to a peer gNB 105 that controls one or more neighboring cells, a current measurement gap pattern of the UE 102. The gNB 105 that controls the serving cell may also propose one or more parameters related to a desired CSI-RS transmission timing. In some cases, the peer gNB 105 may acknowledge that the parameters proposed by the gNB 105 that controls the serving cell are accepted. In some cases, the peer gNB 105 may refuse the proposed parameters and may provide information related to the CSI-RS status of the cells.

Referring to example 950 in FIG. 9, gNB1 960 (which may be the gNB 105 that controls the serving cell) may send the CSI-RS configuration request message 970 to gNB2 965 (which may be the peer gNB 105 that controls the neighboring cells). In addition, gNB2 965 may respond with the CSI-RS configuration response message 975.

In some embodiments, the CSI-RS configuration request message 970 may include one or more of: one or more parameters described herein that may be included in a CSI-RS status request message; one or more measurement gaps per UE (including but not limited to a list of measurement gaps per UE); timing alignment information for the serving cell (which may be used by the neighboring cell(s) to provide CSI-RS measurement on approximate timing of CSI-RS with other cells so measurement gap can be aligned, in some cases); and/or other. In some embodiments, the timing alignment information may include a suggested gap from serving cell point of view, although the target cell may not necessarily comply with the suggested gap. For instance, the suggested gap may reduce network efficiency, and the target cell may therefore decline to use it. In some embodiments, the timing alignment information may reflect the current gaps after source cell collects all neighboring cells gap information up to a current time. In some embodiments, the timing alignment information may include assistance information. In some embodiments, a configuration of the CSI-RS may be determined by the target cell. In some embodiments, a configuration of the CSI-RS may be based at least partly on an implementation (including but not limited to a network implementation).

The table below illustrates an exemplary structure of a Measurement Gap per UE IE. Embodiments are not limited to the type, name, ordering, presence (such as mandatory or optional for a standard), range and/or other aspect of the parameters shown in the table. In some embodiments, the Measurement Gap per UE IE may not necessarily include all parameters shown. In some embodiments, the Measurement Gap per UE IE may include one or more parameters not shown in the table below.

| IE/Group Name | Presence | Range |
|---|---|---|
| Measurement gap per UE | | 1 . . . <maxUEingNB> |
| >gNB1 Xn-AP UE ID | M | |
| >SFN | M | |
| >Start Offset | M | |
| >Start Subframe Time | M | |
| >End Subframe Time | M | |
| >Periodicity | M | |
| >Pattern ID | O | |

In some embodiments, the gNB2 965 may determine (per each cell indicated) if the proposed CSI-RS transmission timing alignment information may be accepted. In some embodiments, such a determination may be based at least partly on the included measurement gaps of the UEs 102 per each cell. In some embodiments, such a determination may be based at least partly on requests from other gNBs 105.

In some embodiments, if the proposed CSI-RS transmission timing alignment information is accepted, gNB2 965 may acknowledge the acceptance by inclusion of an indication in the CSI-RS configuration response message 975 for the cell that accepts the proposed parameters. Otherwise, gNB2 965 may provide the CSI-RS Resource Information IE for the cell.

In some embodiments, the CSI-RS configuration response message 975 may include one or more of: one or more parameters described herein that may be included in a CSI-RS status update message; whether the gNB2 965 has accepted or declined proposed CSI-RS measurement information; and/or other. In some embodiments, the information related to whether the gNB2 965 has accepted or declined proposed CSI-RS measurement information may be per cell. In some embodiments, the information related to whether the gNB2 965 has accepted or declined proposed CSI-RS measurement information may include a list of cells.

In some embodiments, the gNB2 965 may decide to change the CSI-RS transmission timing of a cell based at least partly on one or more of: the proposed CSI-RS transmission timing from gNB1 960, requests from other gNBs 105, included measurement gap of the UE 102 and/or other information. In this case, gNB2 965 may include a modified version of the CSI-RS Resource Information IE in the CSI-RS configuration response message.

In some embodiments, based at least partly on received information from peer gNBs 105 that control the neighboring cells, the serving cell may configure the measurement gap for the UE 102.

It should be noted that techniques, operations, methods and/or messages described herein are not limited to cases of a single UE 102 or to cases of a single serving cell. For instance, the IEs or messages described herein may include information for multiple cells and multiple UEs, in some embodiments.

It should be noted that the mechanisms for measurement gap coordination over Xn interface described herein are not limited by the above exemplary Xn-AP procedures. In some embodiments, such mechanisms may be implemented by other Xn interface procedures or messages or by IEs used by existing Xn-AP or Xn-UP messages which are intended to be communicated between gNBs 105.

In some embodiments, in a radio access network, gNBs 105 and/or other elements may be interconnected by an interface (such as Xn). Messages and/or IEs may be used for communication to support measurement gap coordination between the gNBs 105. In some embodiments, a gNB 105 may request information from other gNBs 105 for measurement gap configuration for a UE 102. The request may be triggered by the UE 102 or by a cell served by the requesting gNB 105 or by the requesting gNB 105. In some embodiments, the request may include one or more of: frequencies on which the serving cell is interested for CSI-RS transmission to the UE 102; cell IDs that the serving cell is interested to get CSI-RS measurement for the UE 102; information on how often (how frequent) the serving cell would like to have CSI-RS measurement per the measured cell; one or more measurement gap configurations; one or more parameters per UE; one or more parameters per serving cell; a range of timing alignment information per serving cell (wherein if neighboring cells can provide CSI-RS measurement on approximate timing of CSI-RS with other cells, the measurement gap can be aligned); and/or other.

In some embodiments, another gNB 105 may respond with a message that includes one or more of: CSI-RS configurations or parameters per measured cell; CSI-RS transmission resource status per measured cell; one or more error cause values per measured cell; acceptance or decline of the requested CSI-RS measurements or parameters with a list of cells. In some embodiments, the gNB 105 may determine the CSI-RS transmission resource status per measured cell based at least partly on received information in the request from other gNBs 105.

In Example 1, a generation Node-B (gNB) may be configurable to operate as a serving cell gNB. An apparatus of the gNB may comprise memory. The apparatus may further comprise processing circuitry. The processing circuitry may be configured to encode, for transmission to a neighbor cell gNB, a channel state information reference signal (CSI-RS) status request message to request timing information for CSI-RS from the neighbor cell gNB. The processing circuitry may be further configured to decode, from the neighbor cell gNB, a CSI-RS status update message that indicates the timing information. The processing circuitry may be further configured to determine, based on the timing information, a measurement gap to be reserved for transmission of the CSI-RS from the neighbor cell gNB to a User Equipment (UE) that is served by the serving cell gNB. The processing circuitry may be further configured to encode, for transmission to the UE, control signaling that indicates the measurement gap. The processing circuitry may be further configured to decode, from the UE, a measurement report that indicates a signal quality measurement based on the CSI-RS from the neighbor cell gNB. The memory may be configured to store information that identifies the measurement gap.

In Example 2, the subject matter of Example 1, wherein the processing circuitry may be further configured to encode the CSI-RS status request message to: indicate a plurality of UEs served by the serving cell gNB; and request per-UE transmissions of a plurality of CSI-RSs by the neighbor cell gNB to the plurality of UEs.

In Example 3, the subject matter of one or any combination of Examples 1-2, wherein the processing circuitry may be further configured to encode the CSI-RS status request message to request the per-UE transmissions in accordance with: different frequency resources of a sub-frame for at least some of the per-UE transmissions, or different transmission directions for at least some of the per-UE transmissions.

In Example 4, the subject matter of one or any combination of Examples 1-3, wherein the processing circuitry may be further configured to decode, in the CSI-RS status update message, a parameter that indicates a periodicity of the CSI-RS from the neighbor cell gNB. The periodicity may be one of 5, 10, 20, 40, and 80 milliseconds. The processing circuitry may be further configured to encode the control signaling to further indicate the periodicity of the CSI-RS from the neighbor cell gNB.

In Example 5, the subject matter of one or any combination of Examples 1-4, wherein the timing information of the CSI-RS status update message may include: a periodicity of the CSI-RS from the neighbor cell gNB; a start sub-frame or an end sub-frame of the CSI-RS from the neighbor cell gNB; or a sub-frame offset, with respect to a system frame number (SFN), of the CSI-RS from the neighbor cell gNB.

In Example 6, the subject matter of one or any combination of Examples 1-5, wherein the timing information of the CSI-RS status update message may be included in a CSI-RS resource information element (IE).

In Example 7, the subject matter of one or any combination of Examples 1-6, wherein the processing circuitry may be further configured to determine, based at least partly on the signal quality measurement, whether a handover of the UE to the neighbor cell gNB is to be initiated.

In Example 8, the subject matter of one or any combination of Examples 1-7, wherein the CSI-RS from the neighbor cell gNB is a first CSI-RS, the measurement report is a first measurement report, and the signal quality measurement is a first signal quality measurement. The processing circuitry may be further configured to encode, for transmission to the UE, second CSI-RS. The processing circuitry may be further configured to decode, from the UE, a second signal quality measurement based on the second CSI-RS. The processing circuitry may be further configured to determine, based at least partly on the first and/or second signal quality measurements, whether a handover of the UE to the neighbor cell gNB is to be initiated.

In Example 9, the subject matter of one or any combination of Examples 1-8, wherein the processing circuitry may be further configured to encode the CSI-RS status request message to request transmission of multiple CSI-RSs by the neighbor cell gNB to the UE. The processing circuitry may be further configured to encode the CSI-RS status request message to indicate one or more of: a plurality of frequency ranges in which the serving cell gNB requests transmission of CSI-RSs by the neighbor cell gNB, and a plurality of neighbor cells for which the serving cell gNB requests transmission of the multiple CSI-RSs by the neighbor cell gNB, wherein the plurality of neighbor cells is supported by the neighbor cell gNB.

In Example 10, the subject matter of one or any combination of Examples 1-9, wherein the processing circuitry may be further configured to encode the CSI-RS status request message to indicate a requested periodicity of the CSI-RS from the neighbor cell gNB.

In Example 11, the subject matter of one or any combination of Examples 1-10, wherein the processing circuitry may be further configured to encode the CSI-RS status request message to request transmission of multiple CSI-RSs by the neighbor cell gNB to a plurality of UEs. The processing circuitry may be further configured to encode the CSI-RS status request message to indicate, on a per-UE basis, one or more of: one or more frequency ranges in which the serving cell gNB requests transmission of CSI-RSs by the neighbor cell gNB, and one or more neighbor cells for which the serving cell gNB requests transmission of the multiple CSI-RSs by the neighbor cell gNB, wherein the plurality of neighbor cells is supported by the neighbor cell gNB.

In Example 12, the subject matter of one or any combination of Examples 1-11, wherein the processing circuitry may be further configured to encode the CSI-RS status request message to request transmission of multiple CSI-RSs in a plurality of neighbor cells supported by the neighbor cell gNB. The processing circuitry may be further configured to encode the CSI-RS status request message to indicate, on a per-cell basis for the plurality of neighbor cells, one or more frequency ranges in which the serving cell gNB requests transmission of CSI-RSs by the neighbor cell gNB.

In Example 13, the subject matter of one or any combination of Examples 1-12, wherein the processing circuitry may be further configured to encode the CSI-RS status request message for transmission to the neighbor cell gNB on an Xn interface. The CSI-RS status update message may be received from the neighbor cell gNB on the Xn interface.

In Example 14, the subject matter of one or any combination of Examples 1-13, wherein the processing circuitry may be further configured to refrain from transmission of signals during the measurement gap.

In Example 15, the subject matter of one or any combination of Examples 1-14, wherein the apparatus may further include a transceiver to transmit the CSI status request message.

In Example 16, the subject matter of one or any combination of Examples 1-15, wherein the processing circuitry may include a baseband processor to encode the CSI status request message.

In Example 17, a computer-readable storage medium may store instructions for execution by one or more processors to perform operations for communication by a generation Node-B (gNB). The gNB may be configurable to operate as a neighbor cell gNB. The operations may configure the one or more processors to decode, from a serving cell gNB, a channel state information reference signal (CSI-RS) status request message to request transmission of CSI-RSs by the neighbor cell gNB to a plurality of User Equipments (UEs) served by the serving cell gNB. The operations may further configure the one or more processors to determine timing information for transmission of the CSI-RSs. The operations may further configure the one or more processors to encode, for transmission to the serving cell gNB, a CSI-RS status update message that indicates the timing information. The operations may further configure the one or more processors to encode the CSI-RSs for transmission to the UEs, wherein the CSI-RSs for at least some of the UEs are different.

In Example 18, the subject matter of Example 17, wherein the operations may further configure the one or more processors to encode the CSI-RSs for per-UE transmissions in accordance with: different frequency resources of a sub-frame for at least some of the per-UE transmissions, or different transmission directions for at least some of the per-UE transmissions.

In Example 19, the subject matter of one or any combination of Examples 17-18, wherein the operations may further configure the one or more processors to select a periodicity for the CSI-RSs as one of 5, 10, 20, 40, and 80 milliseconds. The operations may further configure the one or more processors to encode the CSI-RS status update message to indicate the periodicity.

In Example 20, an apparatus of a User Equipment (UE) may comprise memory. The apparatus may further comprise processing circuitry. The processing circuitry may be configured to decode, from a serving cell Generation Node-B (gNB), control signaling that indicates a measurement gap during which the UE is to receive a channel state information reference signal (CSI-RS) from a neighbor cell gNB. The processing circuitry may be further configured to determine a signal quality measurement based on reception of the CSI-RS from the neighbor cell gNB during the measurement gap. The processing circuitry may be further configured to refrain from reception of signals from the serving cell gNB during the measurement gap. The processing circuitry may be further configured to encode, for transmission to the serving cell gNB, a measurement report that includes the signal quality measurement. The memory may be configured to store information that identifies the measurement gap.

In Example 21, the subject matter of Example 20, wherein the CSI-RS from the neighbor cell gNB is a first CSI-RS, the signal quality measurement is a first signal quality measurement, and the measurement report is a first measurement report. The processing circuitry may be further configured to determine a second signal quality measurement based on reception of a second CSI-RS from the serving cell gNB. The processing circuitry may be further configured to encode, for transmission to the serving cell gNB, a second measurement report that includes the second signal quality measurement.

In Example 22, the subject matter of one or any combination of Examples 20-21, wherein the control signaling may further indicate a periodicity of the CSI-RS. The periodicity may be one of 5, 10, 20, 40, and 80 milliseconds. The processing circuitry may be further configured to decode multiple CSI-RSs received from the neighbor cell gNB in accordance with the periodicity.

In Example 23, a generation Node-B (gNB) may be configurable to operate as a neighbor cell gNB. An apparatus of the gNB may comprise means for decoding, from a serving cell gNB, a channel state information reference signal (CSI-RS) status request message to request transmission of CSI-RSs by the neighbor cell gNB to a plurality of User Equipments (UEs) served by the serving cell gNB. The apparatus may further comprise means for determining timing information for transmission of the CSI-RSs. The apparatus may further comprise means for encoding, for transmission to the serving cell gNB, a CSI-RS status update message that indicates the timing information. The apparatus may further comprise means for encoding the CSI-RSs for transmission to the UEs, wherein the CSI-RSs for at least some of the UEs are different.

In Example 24, the subject matter of Example 23, wherein the apparatus may further comprise means for encoding the CSI-RSs for per-UE transmissions in accordance with: different frequency resources of a sub-frame for at least some of the per-UE transmissions, or different transmission directions for at least some of the per-UE transmissions.

In Example 25, the subject matter of one or any combination of Examples 23-24, wherein the apparatus may further comprise means for selecting a periodicity for the CSI-RSs as one of 5, 10, 20, 40, and 80 milliseconds. The apparatus may further comprise means for encoding the CSI-RS status update message to indicate the periodicity.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1-22. (canceled)

23. An apparatus for use in a base station (BS), which is configurable to operate as a serving cell BS, the apparatus comprising:
memory; and
processing circuitry, configured to:
encode, for transmission to a neighbor cell BS, a channel state information reference signal (CSI-RS) status request message to request timing information for CSI-RS associated with the neighbor cell BS;
decode a CSI-RS status update message that indicates the timing information;
determine, based on the timing information, a measurement gap for transmission of the CSI-RS to a user equipment (UE) that is served by the serving cell BS, wherein the CSI-RS is not to be transmitted by the serving cell BS;
encode, for transmission to the UE, control signaling that indicates the measurement gap; and
decode a measurement report that indicates a signal quality measurement based on the CSI-RS,
wherein the memory is configured to store information that identifies the measurement gap.

24. The apparatus according to claim 23, the processing circuitry further configured to encode the CSI-RS status request message to:
indicate a plurality of UEs served by the serving cell BS; and
request per-UE transmissions of a plurality of CSI-RSs.

25. The apparatus according to claim 23, the processing circuitry further configured to encode the CSI-RS status request message to request the per-UE transmissions in accordance with:
different frequency resources of a sub-frame for at least some of the per-UE transmissions, or
different transmission directions for at least some of the per-UE transmissions.

26. The apparatus according to claim 23, the processing circuitry further configured to:
decode, from the CSI-RS status update message, a parameter that indicates a periodicity of the CSI-RS; and
encode the control signaling to further indicate the periodicity of the CSI-RS.

27. The apparatus according to claim 23, wherein the timing information of the CSI-RS status update message includes:
a periodicity of the CSI-RS;
a start sub-frame or an end sub-frame of the CSI-RS; or
a sub-frame offset, with respect to a system frame number (SFN), of the CSI-RS.

28. The apparatus according to claim 23, wherein the serving cell BS is a gNB of the 3^{rd} Generation Partnership Project (3GPP).

29. The apparatus according to claim 23, the processing circuitry further configured to:
determine, based at least partly on the signal quality measurement, whether a handover of the UE to the neighbor cell BS is to be initiated.

30. The apparatus according to claim 23, wherein the CSI-RS is a first CSI-RS, wherein the measurement report is a first measurement report, wherein the signal quality measurement is a first signal quality measurement, wherein the processing circuitry is further configured to:
encode, for transmission to the UE, second CSI-RS;
decode a second signal quality measurement associated with the second CSI-RS; and
determine, based at least partly on the first and/or second signal quality measurements, whether a handover of the UE is to be initiated.

31. The apparatus according to claim 23, the processing circuitry further configured to:
encode the CSI-RS status request message to request transmission of multiple CSI-RSs by the neighbor cell BS to the UE; and
encode the CSI-RS status request message to indicate one or more of:
a plurality of frequency ranges in which the serving cell BS requests transmission of CSI-RSs by the neighbor cell BS; and
a plurality of neighbor cells for which the serving cell BS requests transmission of the multiple CSI-RSs by the neighbor cell BS.

32. The apparatus according to claim 23, the processing circuitry further configured to:
encode the CSI-RS status request message to indicate a requested periodicity of the CSI-RS.

33. The apparatus according to claim 23, the processing circuitry further configured to:
encode the CSI-RS status request message to request transmission of multiple CSI-RSs by the neighbor cell BS to a plurality of UEs; and
encode the CSI-RS status request message to indicate, on a per-UE basis, one or more of:
one or more frequency ranges in which the serving cell BS requests transmission of the multiple CSI-RSs by the neighbor cell BS; and
one or more neighbor cells for which the serving cell BS requests transmission of the multiple CSI-RSs.

34. The apparatus according to claim 23, the processing circuitry further configured to:
encode the CSI-RS status request message to request transmission of multiple CSI-RSs in a plurality of neighbor cells; and
encode the CSI-RS status request message to indicate, on a per-cell basis for the plurality of neighbor cells, one or more frequency ranges in which the serving cell BS requests transmission of CSI-RSs.

35. The apparatus according to claim 23, the processing circuitry further configured to:
encode the CSI-RS status request message for transmission to the neighbor cell BS on an Xn interface, wherein the CSI-RS status update message is received from the Xn interface.

36. The apparatus according to claim 23, the processing circuitry further configured to:
refrain from transmission of downlink signals during the measurement gap.

37. A non-transitory computer-readable storage medium that stores instructions for communication by a base station (BS), wherein the BS is configurable to operate as a neighbor cell BS, wherein the instructions, when executed by one or more processors, cause the one or more processors to:
decode a channel state information reference signal (CSI-RS) status request message that indicates a request for transmission of CSI-RSs by the neighbor cell BS to a plurality of user equipments (UEs), wherein the neighbor cell BS does not currently serve as a serving cell BS with respect to the UEs;
determine timing information for transmission of the CSI-RSs;
encode, for transmission to a second BS, a CSI-RS status update message that indicates the timing information; and
encode the CSI-RSs for transmission to the UEs, wherein the CSI-RSs for at least some of the UEs are different.

38. The non-transitory computer-readable storage medium according to claim 37, wherein the instructions, when executed by the one or more processors, cause the one or more processors to encode the CSI-RSs for per-UE transmissions in accordance with:
different frequency resources of a sub-frame for at least some of the per-UE transmissions; or
different transmission directions for at least some of the per-UE transmissions.

39. The non-transitory computer-readable storage medium according to claim 37, wherein the instructions, when executed by the one or more processors, cause the one or more processors to:
select a periodicity for the CSI-RSs; and
encode the CSI-RS status update message to indicate the periodicity.

40. An apparatus for use in a user equipment (UE), the apparatus comprising:
memory; and
processing circuitry, configured to:
decode control signaling that indicates a measurement gap during which the UE is to receive a channel state information reference signal (CSI-RS) associated with a neighbor cell base station (BS);
determine a signal quality measurement based on reception of the CSI-RS during the measurement gap;
refrain from reception of downlink signals associated with a serving cell BS during the measurement gap; and
encode, for transmission to the serving cell BS, a measurement report that includes the signal quality measurement,
wherein the memory is configured to store information that identifies the measurement gap.

41. The apparatus according to claim 40, wherein the CSI-RS is a first CSI-RS, wherein the signal quality measurement is a first signal quality measurement, wherein the measurement report is a first measurement report, wherein the processing circuitry is further configured to:
determine a second signal quality measurement based on reception of a second CSI-RS associated with the serving cell BS; and
encode, for transmission to the serving cell BS, a second measurement report that includes the second signal quality measurement.

42. The apparatus according to claim 40, wherein the control signaling further indicates a periodicity of the CSI-RS, wherein the processing circuitry is further configured to decode multiple CSI-RSs associated with the neighbor cell BS in accordance with the periodicity.
